(19) United States
(12) Patent Application Publication
(10) Pub. No.: US 2012/0021662 A1
(43) Pub. Date: Jan. 26, 2012

(54) LAMINATED MATERIAL AND METHOD FOR MAKING THE SAME

(75) Inventors: CHUNG-CHIH FENG, KAOHSIUNG (TW); YUNG-YU FU, KAOHSIUNG (TW); KUN-LIN CHIANG, KAOHSIUNG (TW); JUNG-CHING CHANG, KAOHSIUNG (TW); CHIH-CHENH LIN, KAOHSIUNG (TW); CHUN-WEI WU, KAOHSIUNG (TW); PEI-HUO HUANG, KAOHSIUNG (TW); I-PENG YAO, KAOHSIUNG (TW)

(73) Assignee: SAN FANG CHEMICAL INDUSTRY CO., LTD., KAOHSIUNG CITY (TW)

(21) Appl. No.: 13/170,718

(22) Filed: Jun. 28, 2011

(30) Foreign Application Priority Data
Jul. 20, 2010 (TW) 099123738

(51) Int. Cl. B32B 27/12; B32B 27/40; B32B 7/12; B32B 27/08; B05D 5/10; B32B 38/08

(52) U.S. Cl. 442/286; 427/208.2; 156/280; 156/182; 428/349; 428/339; 442/394; 428/423.1

(57) ABSTRACT

The present invention relates to a laminated material and a method for making the same. The laminated material includes a main layer, a surface layer and an adhesion layer. The main layer at least includes a first polymer resin. The surface layer is disposed on the main layer, the material of the surface layer is a second polymer resin, and the solid content of the second polymer resin is less than that of the first polymer resin. The adhesion layer is disposed under the main layer, and the material of the adhesion layer is thermoplastic resin which is adhesive when being heated, so that the laminated material can be directly attached to another element, thereby simplifying the process and reducing cost.

### BACKGROUND OF THE INVENTION

1. Field of the Invention

The present invention relates to a laminated material and a method for making the same, and more particularly to a laminated material having an adhesion layer on the bottom thereof and a method for making the same.

2. Description of the Related Art

A conventional laminated material (for example: leather or a sheet) is formed by laminating plastic, or by laminating plastic and substrate (for example: woven fabric or non-woven fabric). During the application process, a bonding process for more than two laminated materials may be conducted by various methods, such as high frequency or hot pressing. However, because the bottom of the conventional laminated material itself is not adhesive, the resulting adherence is poor. Therefore, pasting, multi-pasting or machine sewing is necessary to reinforce and improve adherence, leading to greater cost and complication of process.

Conventional laminated material is applied in shoe-manufacturing and other leather post-processing industries. Massive manpower is applied to carrying out the sewing, pasting and other processing procedures, resulting in high production cost.

Therefore, it is necessary to provide a laminated material and a method for making the same to solve the above-mentioned problems.

### SUMMARY OF THE INVENTION

The present invention is directed to a laminated material, comprising a main layer, a surface layer and an adhesion layer. The main layer at least includes a first polymer resin. The surface layer is disposed on the main layer. The material of the surface layer is a second polymer resin, and the solid content of the second polymer resin is less than that of the first polymer resin. The adhesion layer is disposed under the main layer. The material of the adhesion layer is a thermoplastic resin which is adhesive when being heated, so that the laminated material can be directly attached to another element; the softening point of the adhesion layer is 35° C. to 180° C.

The present invention is also directed to a method for making a laminated material, comprising the steps of: (a) forming a second polymer mixture on a release paper, wherein the second polymer mixture includes a second polymer resin; (b) drying the second polymer mixture to form a surface layer; (c) forming a main layer on the surface layer, wherein the main layer at least includes a first polymer resin, and the solid content of the first polymer resin is greater than that of the second polymer resin; (d) forming a thermoplastic resin on the main layer; and (e) drying the thermoplastic resin to form an adhesion layer and obtain a laminated material, wherein the softening point of the adhesion layer is 35° C. to 180° C.

The present invention is also directed to a method for making a laminated material, comprising the steps of: (a) forming a second polymer mixture on a release paper, wherein the second polymer mixture includes a second polymer resin; (b) drying the second polymer mixture to form a surface layer; (c) forming a first glue layer on the surface layer; (d) providing a semi-finished layer including a substrate and a foam layer, wherein the substrate is a woven fabric, a microfiber cloth or a non-woven fabric; (e) laminating the semi-finished layer on the first glue layer; (f) forming a thermoplastic resin on another release paper; (g) drying the thermoplastic resin to form an adhesion layer, wherein the softening point of the adhesion layer is 35° C. to 180° C.; (h) forming a first polymer mixture on the adhesion layer, wherein the first polymer mixture includes a first polymer resin, and the solid content of the first polymer resin is greater than that of the second polymer resin; (i) drying the first polymer mixture to form a high solid layer; (j) forming a second glue layer on the high solid layer; and (k) laminating the structure in Step (e) on the structure in Step (j), wherein the semi-finished layer contacts the second glue layer, and a laminated material is obtained, wherein the semi-finished layer and the high solid layer form a main layer.

Because the adhesion layer is adhesive when being heated, it can be directly attached to another element by various methods such as high frequency or hot pressing. Thus, cementing, pasting, hand sewing or machine sewing are no longer needed, thereby simplifying the process and reducing cost.

### BRIEF DESCRIPTION OF THE DRAWINGS

FIGS. 1 to 4 are schematic views of a method for making a laminated material according to a first embodiment of the present invention;

FIG. 5 is a schematic view of usage condition of the laminated material according to the first embodiment of the present invention;

FIGS. 6 to 10 are schematic views of a method for making a laminated material according to a second embodiment of the present invention; and

FIGS. 11 to 17 are schematic views of a method for making a laminated material according to a third embodiment of the present invention.

### DETAILED DESCRIPTION OF THE INVENTION

FIGS. 1 to 4 show schematic views of a method for making a laminated material according to a first embodiment of the present invention. Referring to FIG. 1, a second polymer mixture is formed on a release paper 10 by coating, wherein the second polymer mixture includes a second polymer resin. The solid content of the second polymer resin is less than 50% by weight, and the second polymer resin is polyurethane (PU) resin, for example: thermoplastic polyurethane (TPU) elastomer, water-soluble elastomer resin or water-dispersed elastomer resin. Then, the second polymer mixture is dried at 50° C. to 130° C. to form a surface layer 12. Preferably, the release paper 10 has a release texture, so that the surface layer 12 has a corresponding surface texture.

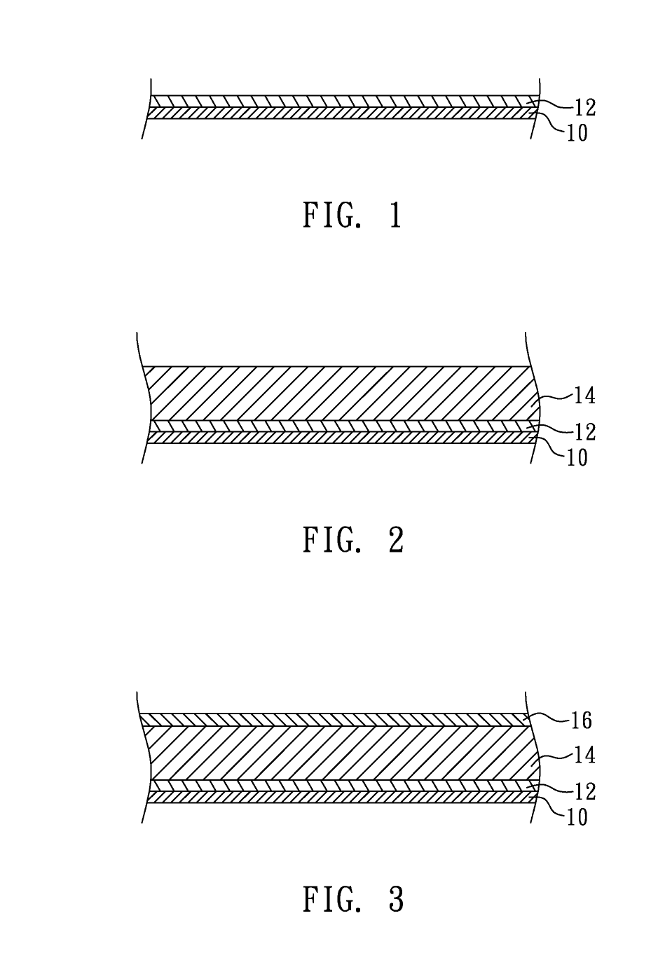

Referring to FIG. 2, a main layer 14 is formed on the surface layer 12, and the main layer 14 at least includes a first polymer resin. The solid content of the first polymer resin is greater than that of the second polymer resin. The main layer 14 may be a single-layered structure or a multi-layered structure. In the embodiment, the main layer 14 is a single-layered structure, which may have foam structure or non-foam structure. The method for forming the main layer 14 is described below. A first polymer mixture is formed on the surface layer 12 by coating or hot-melt laminating, wherein the first polymer mixture includes the first polymer resin. The solid content of the first polymer resin is greater than 70% by weight, and the first polymer resin is polyurethane (PU) resin, thermoplastic polyurethane (TPU) elastomer, ethylene-vinyl acetate (EVA) copolymer, styrene-butadiene (SB), styrene-butadiene-styrene (SBS), polyvinyl chloride (PVC), polyethylene (PE), polyethylene terephthalate (PET) or polystyrene (PS). Then, the first polymer mixture is dried at 100° C. to 150° C. to form the main layer 14.

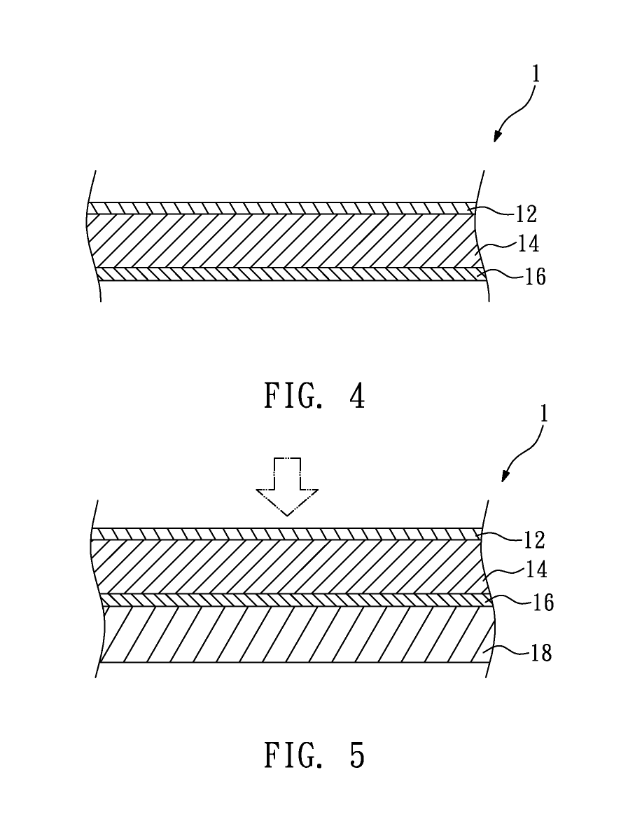

Referring to FIG. 3, a thermoplastic resin is formed on the main layer 14 by coating, and the thermoplastic resin is a polyurethane (PU) adhesive, a polyvinyl chloride (PVC) adhesive, an ethylene-vinyl acetate (EVA) copolymer adhesive, a hot melt adhesive or a mixture thereof The solid content of the polyurethane (PU) adhesive is greater than 10% by weight. Then, the thermoplastic resin is dried at 60° C. to 140° C. to form an adhesion layer 16, and a laminated material 1 (FIG. 4) is obtained after releasing. It is understood that if the thermoplastic resin is a thin film, it is formed on the main layer 14 by hot-melt laminating.

FIG. 4 shows a schematic view of the laminated material according to the first embodiment of the present invention. The laminated material 1 comprises a main layer 14, a surface layer 12 and an adhesion layer 16. The main layer 14 at least includes a first polymer resin. In the embodiment, the main layer 14 is a single-layered structure, the material of the main layer 14 is the first polymer resin, and the solid content of the first polymer resin is greater than 70% by weight. The first polymer resin is polyurethane (PU) resin, thermoplastic polyurethane (TPU) resin, ethylene-vinyl acetate (EVA) copolymer, styrene-butadiene (SB), styrene-butadiene-styrene (SBS), polyvinyl chloride (PVC), polyethylene (PE), polyethylene terephthalate (PET) or polystyrene (PS). Preferably, the thickness of the main layer 14 is 0.2 mm to 6.5 mm.

The surface layer 12 is disposed on the main layer 14, the material of the surface layer 12 is a second polymer resin, and the solid content of the second polymer resin is less than that of the first polymer resin. The solid content of the second polymer resin is less than 50% by weight, and the second polymer resin is polyurethane (PU) resin, for example: thermoplastic polyurethane (TPU) elastomer, water-soluble elastomer resin or water-dispersed elastomer resin. Preferably, the surface layer 12 has a surface texture.

The adhesion layer 16 is disposed under the main layer 14, and the material of the adhesion layer 16 is thermoplastic resin. The softening point of the adhesion layer 16 is 35° C. to 180° C. The adhesion layer 16 is a polyurethane (PU) adhesive, a polyvinyl chloride (PVC) adhesive, an ethylene-vinyl acetate (EVA) copolymer adhesive, a hot melt adhesive or a mixture thereof. The solid content of the polyurethane (PU) adhesive is greater than 10% by weight.

FIG. 5 shows a schematic view of usage condition of the laminated material according to the first embodiment of the present invention. The method for using the laminated material 1 is described below. First, the laminated material 1 is disposed on another element 18 (for example: another laminated material, leather, sheet or substrate), so that the adhesion layer 16 contacts the element 18. Then, a bonding process is conducted by various methods such as high frequency or hot pressing. Because the adhesion layer 16 is adhesive when being heated, the laminated material 1 can be directly attached to the element 18. The laminated material 1 is thus easily bonded to other objects, thus, cementing, pasting, hand sewing or machine sewing is no longer necessary, thereby simplifying the process and reducing cost.

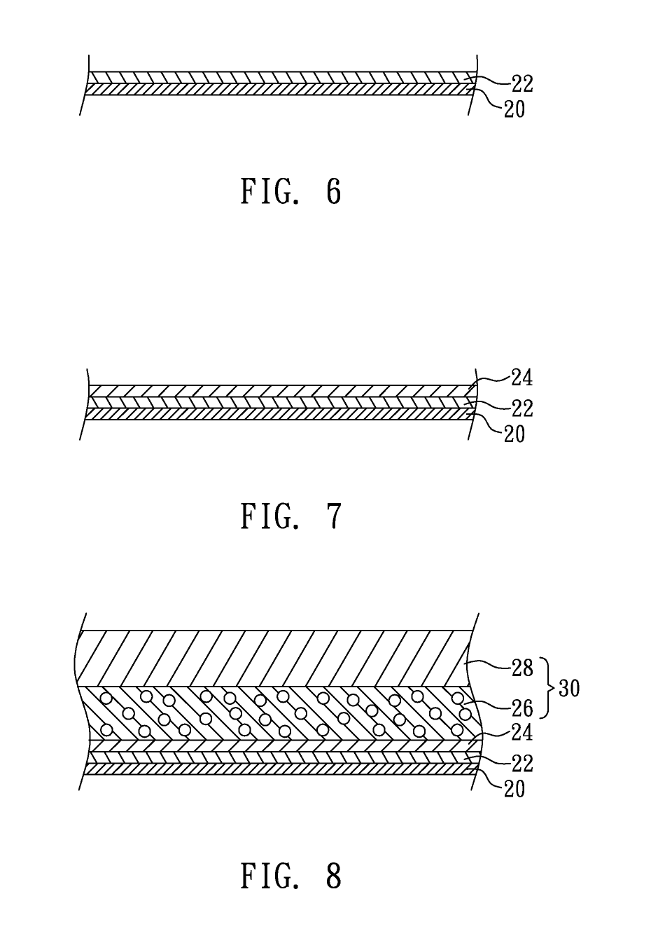

FIGS. 6 to 10 show schematic views of a method for making a laminated material according to a second embodiment of the present invention. Referring to FIG. 6, a second polymer mixture is formed on a release paper 20 by coating, wherein the second polymer mixture includes a second polymer resin. The solid content of the second polymer resin is less than 50% by weight, and the second polymer resin is a polyurethane (PU) resin, for example: thermoplastic polyurethane (TPU) elastomer, water-soluble elastomer resin or water-dispersed elastomer resin. Then, the second polymer mixture is dried at 50° C. to 130° C. to form a surface layer 22. Preferably, the release paper 20 has a release texture, so that the surface layer 22 has a corresponding surface texture.

Referring to FIG. 7, a first glue layer 24 is formed on the surface layer 22 by coating.

Referring to FIG. 8, a main layer 30 is formed on the surface layer 22, so that the main layer 30 is attached to the surface layer 22 by the first glue layer 24. The main layer 30 at least includes a first polymer resin, and the solid content of the first polymer resin is greater than that of the second polymer resin. In the embodiment, the main layer 30 is a double-layered structure, and the method for forming the main layer 30 is described below. First, a semi-finished layer is provided. In the embodiment, the semi-finished layer is a semi-finished product from wet process and includes a substrate 28 and a foam layer 26. The substrate 28 is a woven fabric, a microfiber cloth or a non-woven fabric, and the material of the foam layer 26 is the first polymer resin. The first polymer resin is polyurethane (PU) resin, thermoplastic polyurethane (TPU) resin, ethylene-vinyl acetate (EVA) copolymer, styrene-butadiene (SB), styrene-butadiene-styrene (SBS), polyvinyl chloride (PVC), polyethylene (PE), polyethylene terephthalate (PET) or polystyrene (PS). Then, the semi-finished layer is laminated on the first glue layer 24, wherein the semi-finished layer is the main layer 30.

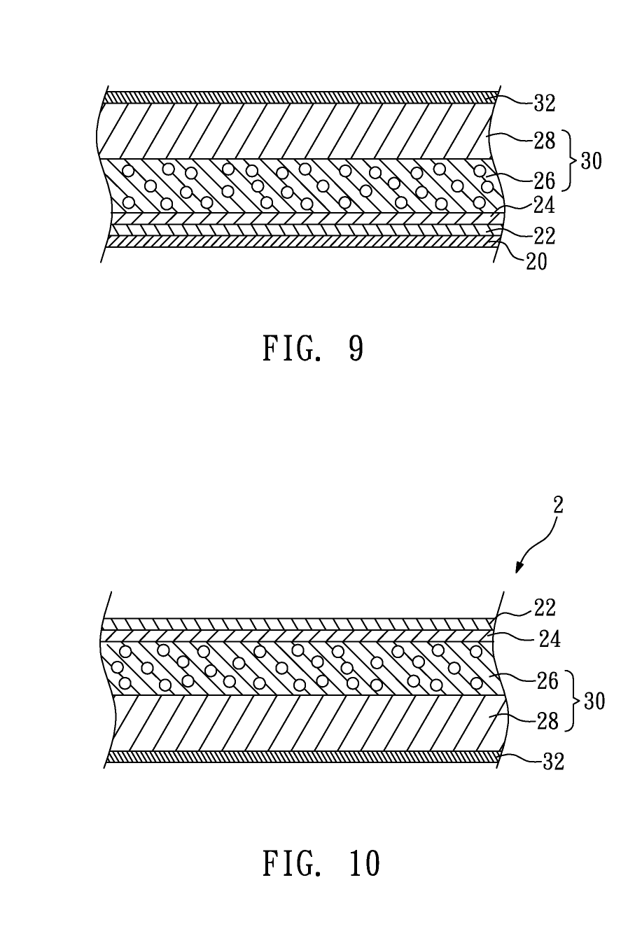

Referring to FIG. 9, a thermoplastic resin is formed on the main layer 30 by coating, and the thermoplastic resin is a polyurethane (PU) adhesive, a polyvinyl chloride (PVC) adhesive, an ethylene-vinyl acetate (EVA) copolymer adhesive, a hot melt adhesive or a mixture thereof The solid content of the polyurethane (PU) adhesive is greater than 10% by weight. Then, the thermoplastic resin is dried at 60° C. to 140° C. to form an adhesion layer 32, and a laminated material 2 (FIG. 10) is obtained after releasing. The softening point of the adhesion layer 32 is 35° C. to 180° C.

FIG. 10 shows a schematic view of the laminated material according to the second embodiment of the present invention. The laminated material 2 comprises a main layer 30, a surface layer 22 and an adhesion layer 32. The main layer 30 is a double-layered structure, and is a semi-finished layer. In the embodiment, the semi-finished layer is a semi-finished product from wet process and includes a substrate 28 and a foam layer 26. The substrate 28 is a woven fabric, a microfiber cloth or a non-woven fabric, and the material of the foam layer 26 is the first polymer resin. The first polymer resin is polyurethane (PU) resin, thermoplastic polyurethane (TPU) resin, ethylene-vinyl acetate (EVA) copolymer, styrene-butadiene (SB), styrene-butadiene-styrene (SBS), polyvinyl chloride (PVC), polyethylene (PE), polyethylene terephthalate (PET) or polystyrene (PS). Preferably, the thickness of the main layer 30 is 0.5 mm to 2.0 mm, and the main layer 30 is attached to the surface layer 22 by a first glue layer 24.

The surface layer 22 is disposed on the main layer 30, and the material of the surface layer 22 is the second polymer resin. The solid content of the second polymer resin is less than that of the first polymer resin. The solid content of the second polymer resin is less than 50% by weight, and the second polymer resin is polyurethane (PU) resin, for example: thermoplastic polyurethane (TPU) elastomer, water-soluble elastomer resin or water-dispersed elastomer resin. Preferably, the surface layer 22 has a surface texture.

The adhesion layer 32 is disposed under the main layer 30, and the material of the adhesion layer 32 is a thermoplastic resin. The adhesion layer 32 is a polyurethane (PU) adhesive, a polyvinyl chloride (PVC) adhesive, an ethylene-vinyl acetate (EVA) copolymer adhesive, a hot melt adhesive or a mixture thereof. The solid content of the polyurethane (PU) adhesive is greater than 10% by weight. The adhesion layer 32 is adhesive when being heated, so that the laminated material 2 can be directly attached to another element. The softening point of the adhesion layer 32 is 35° C. to 180° C.

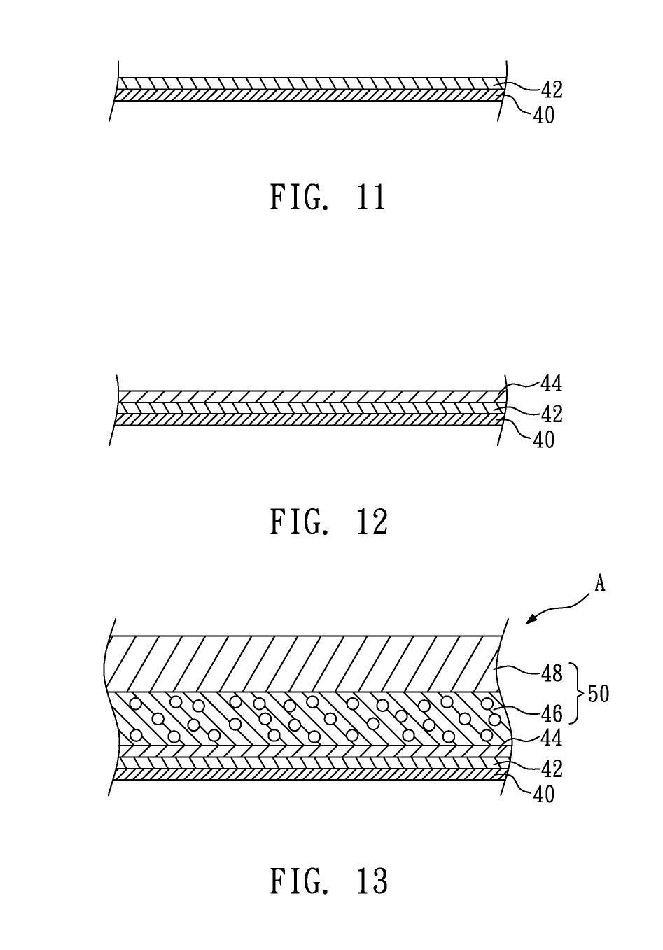

FIGS. 11 to 17 show schematic views of a method for making a laminated material according to a third embodiment of the present invention. Referring to FIG. 11, a second polymer mixture is formed on a release paper 40 by coating, wherein the second polymer mixture includes a second polymer resin. The solid content of the second polymer resin is less than 50% by weight, and the second polymer resin is polyurethane (PU) resin, for example: thermoplastic polyurethane (TPU) elastomer, water-soluble elastomer resin or water-dispersed elastomer resin. Then, the second polymer mixture is dried at 50° C. to 130° C. to form a surface layer 42. Preferably, the release paper 40 has a release texture, so that the surface layer 42 has a corresponding surface texture.

Referring to FIG. 12, a first glue layer 44 is formed on the surface layer 42 by coating.

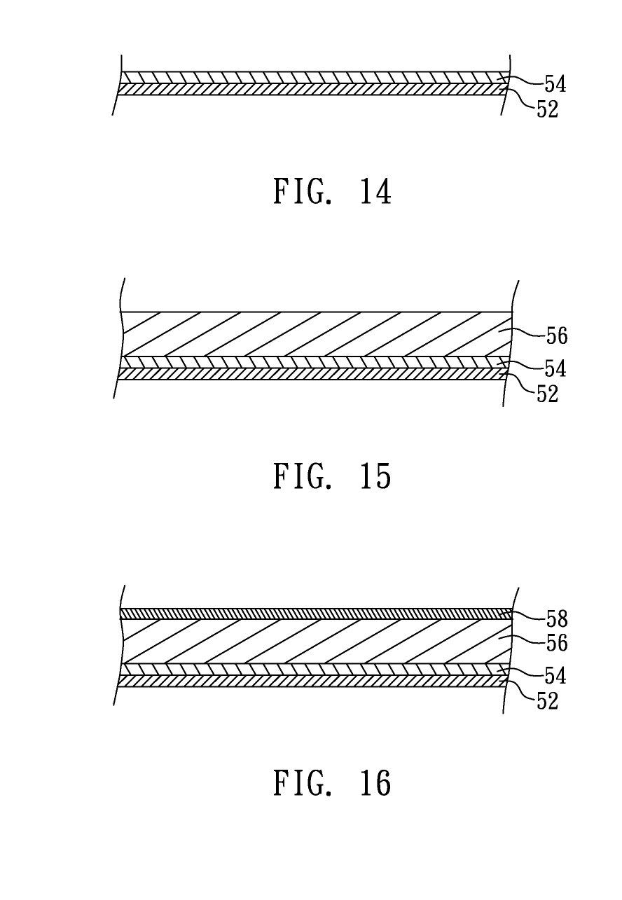

Referring to FIG. 13, a semi-finished layer 50 is provided. In the embodiment, the semi-finished layer 50 is a semi-finished product from wet process and includes a substrate 48 and a foam layer 46. The substrate 48 is a woven fabric, a microfiber cloth or a non-woven fabric, the foam layer 46 is polymer resin, and the polymer resin is a polyurethane (PU) resin. The semi-finished layer 50 is laminated on the first glue layer 44, so as to form a first semi-finished structure A.

Referring to FIG. 14, a thermoplastic resin is formed on another release paper 52 by coating. The thermoplastic resin is a polyurethane (PU) adhesive, a polyvinyl chloride (PVC) adhesive, an ethylene-vinyl acetate (EVA) copolymer adhesive, a hot melt adhesive or a mixture thereof. The solid content of the polyurethane (PU) adhesive is greater than 10% by weight. Then, the thermoplastic resin is dried at 60° C. to 140° C. to form an adhesion layer 54. The softening point of the adhesion layer 54 is 35° C. to 180° C.

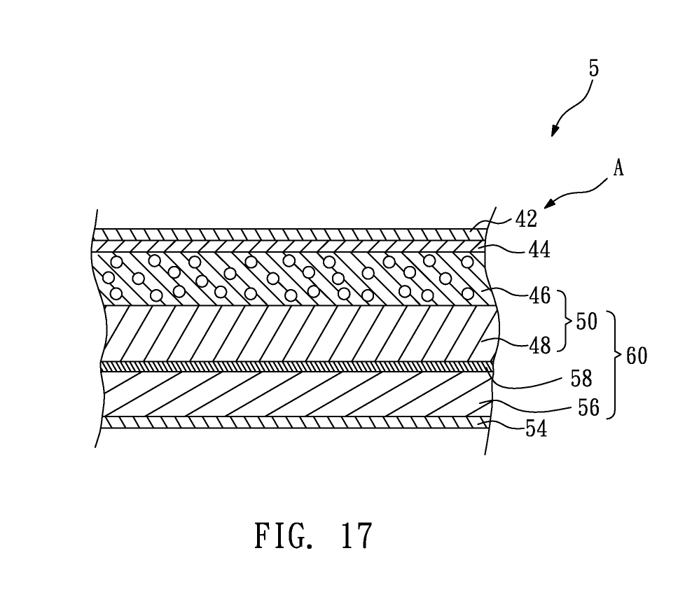

Referring to FIG. 15, a first polymer mixture is formed on the adhesion layer 54 by coating, wherein the first polymer mixture includes the first polymer resin, and the solid content of the first polymer resin is greater than that of the second polymer resin. In the embodiment, the solid content of the first polymer resin is greater than 70% by weight, and the first polymer resin is polyurethane (PU) resin, thermoplastic polyurethane (TPU) resin, ethylene-vinyl acetate (EVA) copolymer, styrene-butadiene (SB), styrene-butadiene-styrene (SBS), polyvinyl chloride (PVC), polyethylene (PE), polyethylene terephthalate (PET) or polystyrene (PS). Then, the first polymer mixture is dried at 100° C. to 150° C. to form a high solid layer 56.

Referring to FIG. 16, a second glue layer 58 is formed on the high solid layer 56 by coating.

Referring to FIG. 17, the first semi-finished structure A in FIG. 13 is laminated on the structure in FIG. 16, wherein the semi-finished layer 50 contacts the second glue layer 58, and a laminated material 5 is obtained after releasing. The semi-finished layer 50 and the high solid layer 56 form a main layer 60, and the adhesion layer 54 is adhesive when being heated, so that the laminated material 5 can be directly attached to another element.

It should be noted that the order of the above-mentioned steps of the embodiment may be changed. That is, the structure in FIG. 16 may be formed before the first semi-finished structure A in FIG. 13 is formed, and then the structure in FIG. 16 is laminated on the first semi-finished structure A in FIG. 13.

FIG. 17 shows a schematic view of the laminated material according to the third embodiment of the present invention. The laminated material 5 comprises a main layer 60, a surface layer 42 and an adhesion layer 54. The main layer 60 comprises a high solid layer 56 and a semi-finished layer 50. In the embodiment, the semi-finished layer 50 is a semi-finished product from wet process and includes a substrate 48 and a foam layer 46. The substrate 48 is a woven fabric, a microfiber cloth or a non-woven fabric, the foam layer 46 is polymer resin, and the polymer resin is polyurethane (PU) resin. Preferably, the thickness of the main layer 60 is 0.5 mm to 5.5 mm. The semi-finished layer 50 is attached to the surface layer 42 by a first glue layer 44, and the semi-finished layer 50 is attached to the high solid layer 56 by a second glue layer 58. Therefore, the surface layer 42 is disposed on the semi-finished layer 50, the high solid layer 56 is disposed under the semi-finished layer 50, and the adhesion layer 54 is disposed under the high solid layer 56.

The material of the high solid layer 56 is the first polymer resin, preferably the solid content of the first polymer resin is greater than 70% by weight, and the first polymer resin is polyurethane (PU) resin, thermoplastic polyurethane (TPU) resin, ethylene-vinyl acetate (EVA) copolymer, styrene-butadiene (SB), styrene-butadiene-styrene (SBS), polyvinyl chloride (PVC), polyethylene (PE), polyethylene terephthalate (PET) or polystyrene (PS).

The surface layer 42 is disposed on the main layer 60, the material of the surface layer 42 is the second polymer resin, and the solid content of the second polymer resin is less than that of the first polymer resin. The solid content of the second polymer resin is less than 50% by weight, and the second polymer resin is polyurethane (PU) resin, for example: thermoplastic polyurethane (TPU) elastomer, water-soluble elastomer resin or water-dispersed elastomer resin. Preferably, the surface layer 42 has a surface texture.

The adhesion layer 54 is disposed under the main layer 60, and the material of the adhesion layer 54 is thermoplastic resin. The adhesion layer 54 is a polyurethane (PU) adhesive, a polyvinyl chloride (PVC) adhesive, an ethylene-vinyl acetate (EVA) copolymer adhesive, a hot melt adhesive or a mixture thereof The solid content of the polyurethane (PU) adhesive is greater than 10% by weight. The adhesion layer 54 is adhesive when being heated, so that the laminated material 5 can be directly attached to another element. The softening point of the adhesion layer 54 is 35° C. to 180° C.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A laminated material, comprising:
a main layer, including a first polymer resin;
a surface layer, disposed on the main layer, wherein the material of the surface layer is a second polymer resin, and the solid content of the second polymer resin is less than that of the first polymer resin; and
an adhesion layer, disposed under the main layer, wherein the material of the adhesion layer is a thermoplastic resin which is adhesive when being heated, so that the laminated material can be directly attached to another element, and the softening point of the adhesion layer is 35° C. to 180° C.

2. The laminated material as claimed in claim 1, wherein the solid content of the first polymer resin is greater than 70% by weight, the solid content of the second polymer resin is less than 50% by weight, and the thickness of the main layer is 0.2 mm to 6.5 mm.

3. The laminated material as claimed in claim 1, wherein the first polymer resin is polyurethane (PU) resin, thermoplastic polyurethane (TPU) resin, ethylene-vinyl acetate (EVA) copolymer, styrene-butadiene (SB), styrene-butadiene-styrene (SBS), polyvinyl chloride (PVC), polyethylene (PE), polyethylene terephthalate (PET) or polystyrene (PS), the second polymer resin is polyurethane (PU) resin, and the adhesion layer is a polyurethane (PU) adhesive, a polyvinyl chloride (PVC) adhesive, an ethylene-vinyl acetate (EVA) copolymer adhesive, a hot melt adhesive or a mixture thereof.

4. The laminated material as claimed in claim 1, wherein the main layer is a single-layered structure, the material of the main layer is the first polymer resin, and the main layer, the surface layer and the adhesion layer are all formed by coating.

5. The laminated material as claimed in claim 1, wherein the main layer includes a semi-finished layer and a high solid layer, the semi-finished layer includes a substrate and a foam layer, the substrate is a woven fabric, a microfiber cloth or a non-woven fabric, and the material of the high solid layer is the first polymer resin.

6. The laminated material as claimed in claim 5, wherein the surface layer is disposed on the semi-finished layer, the high solid layer is disposed under the semi-finished layer, and the adhesion layer is disposed under the high solid layer.

7. The laminated material as claimed in claim 1, wherein the main layer is a semi-finished layer including a substrate and a foam layer, the substrate is a woven fabric, a microfiber cloth or a non-woven fabric, the material of the foam layer is the first polymer resin, and the first polymer resin is polyurethane (PU) resin.

8. A method for making a laminated material, comprising the steps of:
(a) forming a second polymer mixture on a release paper, wherein the second polymer mixture includes a second polymer resin;
(b) drying the second polymer mixture to form a surface layer;
(c) forming a main layer on the surface layer, wherein the main layer includes a first polymer resin, and the solid content of the first polymer resin is greater than that of the second polymer resin;
(d) forming a thermoplastic resin on the main layer; and
(e) drying the thermoplastic resin to form an adhesion layer and obtain a laminated material, wherein the adhesion layer is adhesive when being heated, so that the laminated material can be directly attached to another element, and the softening point of the adhesion layer is 35° C. to 180° C.

9. The method as claimed in claim 8, wherein the release paper has a release texture in Step (a), so that the surface layer has a corresponding surface texture in Step (b).

10. The method as claimed in claim 8, wherein the solid content of the second polymer resin is less than 50% by weight in Step (a), and the second polymer resin is a solvent-free polyurethane (PU) resin in Step (a).

11. The method as claimed in claim 8, wherein Step (c) comprises:
(c1) forming a first polymer mixture on the surface layer, wherein the first polymer mixture includes the first polymer resin; and
(c2) drying the first polymer mixture to form the main layer, wherein the main layer is a single-layered structure.

12. The method as claimed in claim 8, wherein Step (c) comprises:
(c1) forming a first glue layer on the surface layer;
(c2) providing a semi-finished layer including a substrate and a foam layer, wherein the substrate is a woven fabric, a microfiber cloth or a non-woven fabric, the material of the foam layer is the first polymer resin, and the first polymer resin is a polyurethane (PU) resin; and
(c3) laminating the semi-finished layer on the first glue layer, wherein the semi-finished layer is the main layer.

13. The method as claimed in claim 8, wherein the second polymer mixture is formed on the release paper by coating in Step (a), and the thermoplastic resin is formed on the main layer by coating or hot-melt laminating in Step (d).

14. A method for making a laminated material, comprising the steps of:
(a) forming a second polymer mixture on a release paper, wherein the second polymer mixture includes a second polymer resin;
(b) drying the second polymer mixture to form a surface layer;
(c) forming a first glue layer on the surface layer;
(d) providing a semi-finished layer including a substrate and a foam layer, wherein the substrate is a woven fabric, a microfiber cloth or a non-woven fabric;
(e) laminating the semi-finished layer on the first glue layer;
(f) forming a thermoplastic resin on another release paper;
(g) drying the thermoplastic resin to form an adhesion layer, wherein the softening point of the adhesion layer is 35° C. to 180° C.;
(h) forming a first polymer mixture on the adhesion layer, wherein the first polymer mixture includes a first polymer resin, and the solid content of the first polymer resin is greater than that of the second polymer resin;
(i) drying the first polymer mixture to form a high solid layer;
(j) forming a second glue layer on the high solid layer; and
(k) laminating the structure in Step (e) on the structure in Step (j), wherein the semi-finished layer contacts the second glue layer, a laminated material is obtained, wherein the semi-finished layer and the high solid layer form a main layer, and the adhesion layer is adhesive when being heated, so that the laminated material can be directly attached to another element.

15. The method as claimed in claim 14, wherein the release paper has a release texture in Step (a), so that the surface layer has a corresponding surface texture in Step (b).

16. The method as claimed in claim 14, wherein the solid content of the second polymer resin is less than 50% by weight in Step (a).

17. The method as claimed in claim 14, wherein the second polymer resin is polyurethane (PU) resin in Step (a).

18. The method as claimed in claim 14, wherein the thermoplastic resin is a polyurethane (PU) adhesive, a polyvinyl chloride (PVC) adhesive, an ethylene-vinyl acetate (EVA) copolymer adhesive, a hot melt adhesive or a mixture thereof in Step (f).

19. The method as claimed in claim 14, wherein the first polymer resin is polyurethane (PU) resin in Step (h).

20. The method as claimed in claim 14, wherein the second polymer mixture is formed on the release paper by coating in Step (a), the thermoplastic resin is formed on the another release paper by coating in Step (f), and the first polymer mixture is formed on the adhesion layer by coating or hot-melt laminating in Step (h).
